(19) United States
(12) Patent Application Publication
(10) Pub. No.: US 2026/0260463 A1
(43) Pub. Date: Sep. 3, 2026

(54) IMAGE SELECTION METHOD, TRAINING METHOD, IMAGE SELECTION DEVICE, AND RECORDING MEDIUM

(71) Applicant: Panasonic Intellectual Property Management Co., Ltd., Osaka (JP)

(72) Inventors: Yuzuru NAKAMURA, Osaka (JP); Yasunori ISHII, Osaka (JP)

(21) Appl. No.: 19/660,485

(22) Filed: Apr. 28, 2026

Related U.S. Application Data
(63) Continuation of application No. PCT/JP2024/038649, filed on Oct. 30, 2024.
(60) Provisional application No. 63/598,593, filed on Nov. 14, 2023.

(30) Foreign Application Priority Data
May 14, 2024 (JP) 2024-078426

(51) Int. Cl. G06V 10/764; G06V 10/778

(52) U.S. Cl. CPC G06V 10/764; G06V 10/778

(57) ABSTRACT

An image selection method executed by a processor using memory includes: predicting a degree of missed detection based on a number of undetected objects in each of a plurality of unlabeled images by inputting the plurality of unlabeled images into an undetected object prediction model; and selecting one or more unlabeled images to be labeled from among the plurality of unlabeled images, based on the degree of missed detection of each of the plurality of unlabeled images.

### CROSS REFERENCE TO RELATED APPLICATIONS

This is a continuation application of PCT International Application No. PCT/JP2024/038649 filed on Oct. 30, 2024, designating the United States of America, which is based on and claims priority of U.S. Provisional Patent Application No. 63/598,593 filed on Nov. 14, 2023, and Japanese Patent Application No. 2024-078426 filed on May 14, 2024. The entire disclosures of the above-identified applications, including the specifications, drawings, and claims are incorporated herein by reference in their entirety.

### FIELD

The present disclosure relates to an image selection method, a training method, an image selection device, and a recording medium.

### BACKGROUND

Various methods are being studied as training methods for machine learning models using neural networks and the like. For example, Patent Literature (PTL) 1 discloses a training device for a machine learning model that can accurately realize image recognition such as object detection.

### CITATION LIST

### Patent Literature

PTL 1: Japanese Unexamined Patent Application Publication No. 2024-006730

### SUMMARY

### Technical Problem

When training machine learning models, while both the collection of training images and their annotation are necessary steps, the annotation process is costly.

Accordingly, the present disclosure provides an image selection method, a training method, an image selection device, and a recording medium that enable effective training of a machine learning model while reducing the cost of annotation for training the machine learning model.

### Solution to Problem

An image selection method according to one aspect of the present disclosure is executed by a processor using memory, and includes: estimating a degree of missed detection based on a number of undetected objects in each of a plurality of unlabeled images, by inputting the plurality of unlabeled images into an undetected object prediction model; and selecting one or more unlabeled images to be labeled from among the plurality of unlabeled images, based on the degree of missed detection of each of the plurality of unlabeled images.

A training method according to one aspect of the present disclosure includes: labeling each of the one or more unlabeled images selected using the above-described image selection method; and training a target model to be trained using one or more labeled images that are the one or more unlabeled images assigned with labels.

An image selection device according to one aspect of the present disclosure includes: an estimator that estimates a degree of missed detection based on a number of undetected objects in each of a plurality of unlabeled images, by inputting the plurality of unlabeled images into an undetected object prediction model; and a selector that selects one or more unlabeled images for labeling from among the plurality of unlabeled images, based on the degree of missed detection of each of the plurality of unlabeled images.

A recording medium according to one aspect of the present disclosure is a non-transitory computer-readable recording medium having recorded thereon a computer program for causing a computer to execute the above-described image selection method.

### Advantageous Effects

According to one aspect of the present disclosure, it is possible to realize an image selection method and the like that enable effective training of a machine learning model while reducing the cost of annotation for training the machine learning model.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating the functional configuration of an information processing device according to an embodiment of the present disclosure.

FIG. 2 is a flowchart illustrating the operation of an information processing device according to an embodiment of the present disclosure.

FIG. 3 is a diagram for explaining the training process of a target model according to an embodiment of the present disclosure.

FIG. 4 is a diagram for explaining the training process of an FNPM according to an embodiment of the present disclosure.

### Description of Embodiment(s)

### (Circumstances Leading to the Present Disclosure)

Prior to describing the present disclosure, the circumstances leading to the present disclosure will be described.

When domains, which conceptually are collections of data from specific environments, differ from one another, the visual characteristics in images can vary, potentially reducing the recognition performance of the machine learning model. Therefore, it is desirable to adapt the machine learning model from an existing environment (source domain) to a new environment (target domain). Note that adapting the machine learning model from an existing environment to a new environment is also referred to as domain adaptation (active domain adaptation (ADA)). Examples of machine learning models include, for instance, those that perform image recognition through deep learning, particularly for object detection. Object detection refers to outputting the position and class of objects in an image.

Conventionally, to adapt a machine learning model to a domain, images are collected in the new environment, annotation information (training labels) is assigned, and retraining is performed, but this approach is both costly and labor-intensive for annotation. It is desirable for machine learning models to be deployed in various environments and to perform recognition with high accuracy. For example, it is desirable to inhibit a reduction in recognition performance of the machine learning model due to differences in the application environment. Because the performance of a machine learning model depends on the images used during training, it is believed that generating such a machine learning model would require even greater annotation costs.

Here, a method of domain adaptation is under consideration that involves assigning training labels to only a small number (for example, approximately several percent) of images (unlabeled images) in the new environment and training (for example, retraining) the machine learning model using the images in the new environment assigned with the training labels. For example, ADA technology that effectively samples and uses a small number of images in the target domain is being considered. Because annotation only needs to be performed on a small number of images, it is possible to reduce the cost of annotation for training the machine learning model.

In such cases, it is desirable to further improve (for example, maximize) the performance of the machine learning model by selecting and labeling images that are effective for training and using them for training. For example, it is believed that selecting images that the machine learning model appears to struggle with as images to be assigned labels can contribute to improving training efficiency. Images that the machine learning model appears to struggle with can be identified based on the uncertainty of the detection results estimated by the machine learning model.

However, object detection is susceptible to a distinctive type of error known as false negatives (missed detection). Conventionally, uncertainty is measured after the model detects an object, so if the object is missed in the first place, the uncertainty measurement itself cannot be performed. In particular, in situations where the environment has changed and the appearance (look) of images differs (i.e., under domain shift), an increase in undetected objects can be a factor in reduced accuracy, so countermeasures against undetected objects are important. Note that a change in environment means, for example, that the environment in which images were captured differs between images used during training of the machine learning model and images captured in an environment where the machine learning model is used, and includes, for example, at least one of the following being different: lighting environment (visible light, infrared), weather (clear, cloudy, rain, snow, fog), time of day (morning, noon, night), image type (CG, live-action), and the like.

Accordingly, the inventors of the present application conceived that by selecting images that are likely to have many false negatives (i.e., images including undetected objects) in a target model, which is an object detection model to be trained, as images to be labeled, undetected objects can be effectively reduced in the target model, and devised an image selection method and the like that enable estimation of the number of undetected objects in an image and selection of images to be used for training based on the estimated number of undetected objects, that is, an image selection method and the like that enable effective training of a machine learning model while reducing the cost of annotation for training the machine learning model. The image selection method and the like is a method for selecting samples by quantifying the degree of missed detection of objects in object detection.

Note that it is believed that by selecting images captured in a new environment in the image selection method of the present application, performance degradation under domain shift can also be improved. For example, by using the image selection method of the present application, it is possible to both improve performance degradation due to domain shift and reduce annotation cost.

An image selection method according to a first aspect of the present disclosure is executed by a processor using memory, and includes: estimating a degree of missed detection based on a number of undetected objects in each of a plurality of unlabeled images, by inputting the plurality of unlabeled images into an undetected object prediction model; and selecting one or more unlabeled images to be labeled from among the plurality of unlabeled images, based on the degree of missed detection of each of the plurality of unlabeled images.

With this, images including undetected objects are selected as images to be labeled, and therefore, when training a machine learning model using such images, the detection performance of the machine learning model for undetected objects can be effectively improved. Because it is not necessary to assign labels to each of the plurality of unlabeled images, the cost of annotation for training the machine learning model can be reduced. Therefore, with the image selection method according to one aspect of the present disclosure, it is possible to effectively train a machine learning model while reducing the cost of annotation for training the machine learning model.

For example, an image selection method according to a second aspect may be the image selection method according to the first aspect, further including: predicting a first degree of missed detection for an input image by inputting the input image into the undetected object prediction model; calculating a second degree of missed detection for the input image, based on ground truth information of an object region in the input image; and training the undetected object prediction model based on the first degree of missed detection and the second degree of missed detection.

With this, the undetected object prediction model can be trained to accurately predict the number of undetected objects. Stated differently, unlabeled images that can more effectively train the machine learning model can be selected as images to be labeled. Therefore, the machine learning model can be trained more effectively.

For example, an image selection method according to a third aspect may be the image selection method according to the first aspect or the second aspect, wherein the one or more unlabeled images are images selected from among the plurality of unlabeled images based on a magnitude of the degree of missed detection.

With this, images to be labeled can be selected based on the degree of missed detection. By using such images, the machine learning model can be trained more effectively.

For example, an image selection method according to a fourth aspect may be the image selection method according to the third aspect, wherein the one or more unlabeled images are images, among the plurality of unlabeled images, for which the degree of missed detection is greater than or equal to a first predetermined degree, or are a second predetermined number of top images.

With this, unlabeled images that include many undetected objects can be preferentially selected and labeled. By training a machine learning model using such images, a machine learning model that is robust to undetected objects can be realized.

For example, an image selection method according to a fifth aspect may be the image selection method according to any one of the first aspect to the fourth aspect, wherein the one or more unlabeled images are images selected further based on a metric based on a confidence level of a detected object in each of the plurality of unlabeled images.

With this, images to be labeled can be selected based on the number of undetected objects and a metric based on the confidence level of detected objects. By using such images, the detection performance of the machine learning model for undetected objects and for objects corresponding to the metric can be effectively improved. Therefore, the machine learning model can be trained even more effectively.

For example, an image selection method according to a sixth aspect may be the image selection method according to the fifth aspect, wherein the metric includes an uncertainty indicating a degree of variation in predictions in the undetected object prediction model.

With this, images that can reduce uncertainty, i.e., false detections, can be selected as images to be labeled. By using such images, the detection performance of the machine learning model for undetected objects and false detections can be effectively improved.

For example, an image selection method according to a seventh aspect may be the image selection method according to any one of the first aspect to the sixth aspect, wherein the number of undetected objects is, when an image is input into a target model to be trained, a number of objects, among a plurality of objects included in the image, that are undetectable by the target model.

With this, images that include objects that are undetectable by the target model to be trained can be labeled. Therefore, the target model can be trained more effectively.

For example, an image selection method according to an eighth aspect may be the image selection method according to the seventh aspect, wherein the target model has been trained using images captured in a first environment, and the plurality of unlabeled images include images captured in a second environment different from the first environment.

With this, the detection performance for images captured in the second environment, that is, images that look different from images captured in the first environment, can be effectively improved. Therefore, performance degradation due to domain shift can be effectively inhibited.

A training method according to a ninth aspect includes: labeling each of the one or more unlabeled images selected using the image selection method according to any one of the first aspect to the eighth aspect; and training a target model to be trained using one or more labeled images that are the one or more unlabeled images assigned with labels.

With this, the same effects as the image selection method described above are achieved.

An image selection device according to a tenth aspect of the present disclosure includes: an estimator that estimates a degree of missed detection based on a number of undetected objects in each of a plurality of unlabeled images, by inputting the plurality of unlabeled images into an undetected object prediction model; and a selector that selects one or more unlabeled images for labeling from among the plurality of unlabeled images, based on the degree of missed detection of each of the plurality of unlabeled images.

With this, the same effects as the image selection method described above are achieved.

A recording medium according to an eleventh aspect of the present disclosure is a non-transitory computer-readable recording medium having recorded thereon a computer program for causing a computer to execute the image selection method according to any one of the first aspect to the eighth aspect.

With this, the same effects as the image selection method described above are achieved.

General or specific aspects of the present disclosure may be realized as a system, a method, an integrated circuit, a computer program, a computer-readable non-transitory recording medium such as a CD-ROM, or any given combination thereof. The program may be pre-stored on the recording medium, or may be supplied to the recording medium via a wide area communications network, including the internet.

Hereinafter, an embodiment of the present disclosure will be described in detail with reference to the drawings.

The embodiments described below each illustrate comprehensive or specific examples of the present disclosure. The numerical values, shapes, elements, the arrangement and connection of the elements, steps, order of the steps, etc., shown in the following embodiments are mere examples, and therefore do not limit the scope of the present disclosure. Accordingly, among the elements in the following embodiments, those not recited in any of the independent claims are described as optional elements.

The figures are schematic diagrams and are not necessarily precise illustrations. Therefore, for example, the scale in the figures may not necessarily be consistent. In the figures, elements that are essentially the same share the same reference signs, and repeated description may be omitted or simplified.

In the present specification, terms indicating relationships between elements such as “same”, numerical values, and numerical ranges refer not only to their strict meanings, but encompass a range of essentially equivalents, such as a range of deviations of a small percent (or approximately 10%).

In the present specification, ordinal numbers such as “first” and “second” are used not to imply a specific number or order of elements, unless specifically stated otherwise, but rather to avoid confusion among similar components and to distinguish them.

### Embodiment

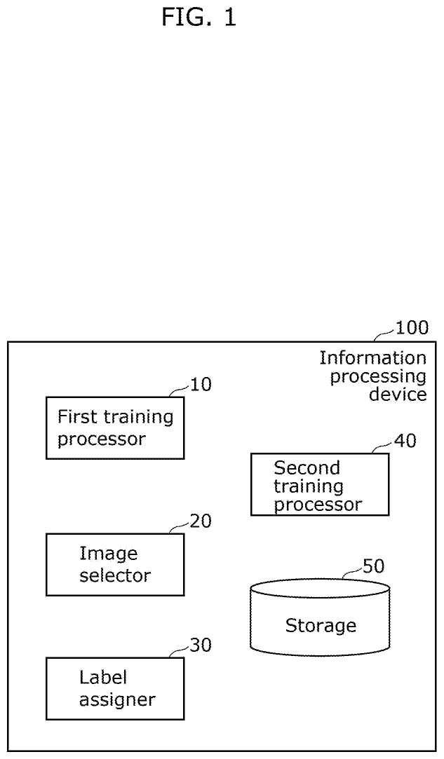

Hereinafter, the information processing device according to the present embodiment will be described with reference to FIG. 1 through FIG. 4.

### [1. Configuration of Information Processing Device]

First, the configuration of the information processing device according to the present embodiment will be described with reference to FIG. 1. FIG. 1 is a block diagram illustrating the functional configuration of information processing device 100 according to the present embodiment.

As illustrated in FIG. 1, information processing device 100 includes, as a functional configuration, first training processor 10, image selector 20, label assigner 30, second training processor 40, and storage 50. Information processing device 100 also includes, as a hardware configuration, for example, non-volatile memory in which programs are stored, volatile memory that is a temporary storage area for executing programs, input/output ports, a communication interface, and a processor that executes programs. The memory is, for example, read only memory (ROM) and random access memory (RAM), and can store programs executed by the processor. First training processor 10, image selector 20, label assigner 30, and second training processor 40 are realized by a processor or the like that executes programs stored in memory (for example, storage 50).

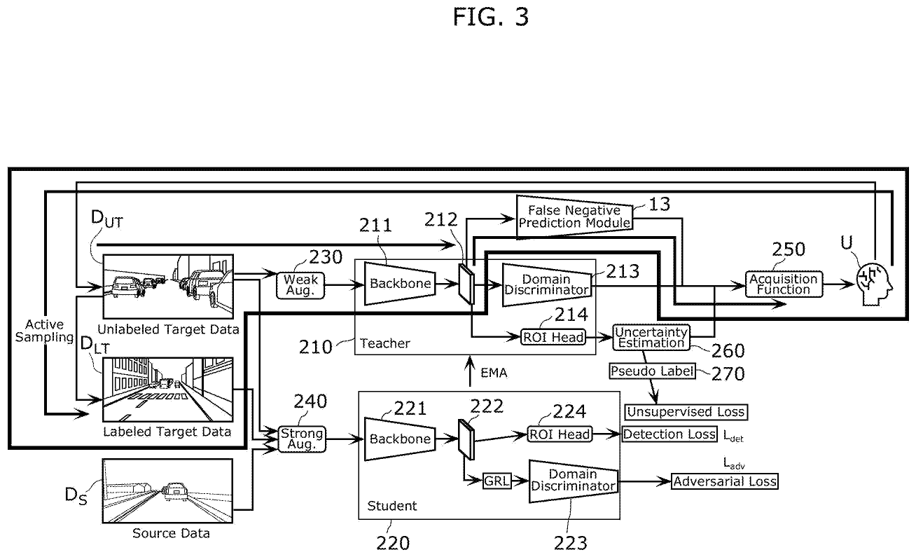

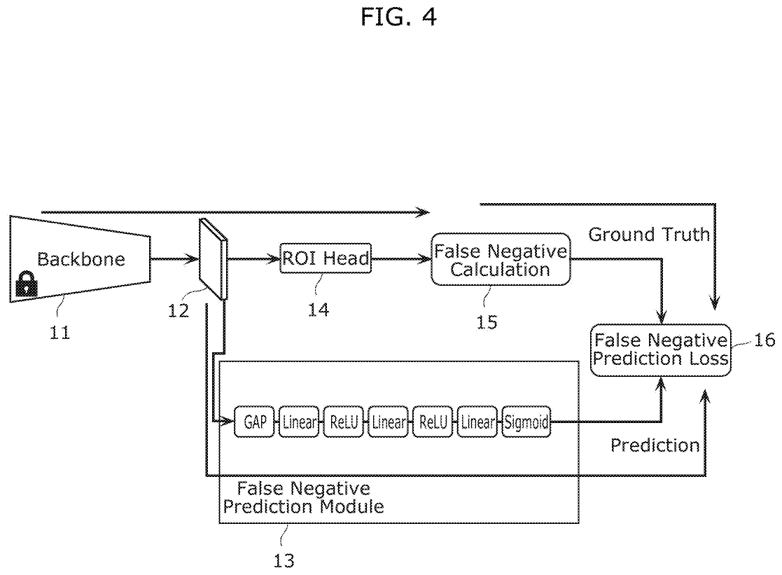

First training processor 10 executes a process of training a false negative prediction module (FNPM 13 illustrated in FIG. 3 to be described later), which is a machine learning model that estimates the number of undetected objects (number of false negatives) in an input image, in order to realize an active learning approach that accounts for undetected objects. The training process method and the detailed configuration of first training processor 10 will be described later with reference to FIG. 4.

Image selector 20 executes a process of selecting a small number of target images to be labeled from a plurality of images (unlabeled images) using FNPM 13 trained by first training processor 10. Image selector 20 actively samples images that include undetected objects. The plurality of images here may include, for example, images captured in a new environment that is different from the existing environment in which images used for training the target model were captured. The number of target images to be selected is set in advance and may be, for example, approximately several percent of the total number of the plurality of unlabeled images. Image selector 20 functions as a selector.

Note that the target model is a machine learning model that uses a neural network such as deep learning (e.g., a convolutional neural network (CNN)), and examples include Fast R-CNN, but other machine learning models such as R-CNN, Faster R-CNN, single shot multibox detector (SSD), and you only look once (YOLO) may be used.

Image selector 20 estimates a degree of missed detection based on a number of undetected objects in each of the plurality of unlabeled images by inputting the plurality of unlabeled images (specifically, feature amounts of the plurality of unlabeled images) into FNPM 13, and selects target images from the plurality of unlabeled images based on the estimation result. Image selector 20 may select, as target images, images among the plurality of unlabeled images for which the degree of missed detection is greater than or equal to a first predetermined degree, or a second predetermined number of top images. Note that the number of target images may be one or more. The first predetermined degree and the second predetermined number are, for example, set in advance and stored in storage 50. In this way, image selector 20 functions as an estimator that estimates the degree of missed detection using FNPM 13.

Note that image selector 20 may select target images based on a metric based on a confidence level of a detected object in each of the plurality of unlabeled images, in addition to the degree of missed detection. The metric based on confidence level includes, for example, uncertainty. For example, image selector 20 may select target images from the plurality of unlabeled images based on the degree of missed detection and uncertainty. Stated differently, image selector 20 may select target images from the plurality of unlabeled images in consideration of undetected objects and falsely detected objects. Even when an object is detected in an image of a new environment, it is assumed that uncertainty will be high. By selecting images with high levels of uncertainty, the system can effectively identify images from new environments.

Note that missed detection includes failure to detect an object to be detected in the machine learning model (i.e., a false negative). Note that false detection includes misidentifying the class of an object, detecting an object at an incorrect position in the image, detecting the background (i.e., a region where no object to be detected is present) as an object to be detected, and the like. Uncertainty refers to the degree of variation in predictions in deep learning. For example, the smaller the difference in probability distributions for each class, the more scattered the predictions are, and the greater the uncertainty. Note that the metric based on confidence level is not limited to uncertainty.

Label assigner 30 executes a process of assigning labels to target images selected by image selector 20 from among the plurality of unlabeled images. Label assigner 30 assigns labels to, for example, only the target images from among the plurality of unlabeled images. Stated differently, among the plurality of unlabeled images, label assigner 30 prohibits assigning labels to unlabeled images other than the target images.

Label assigner 30 may receive input of label information from a user and assign labels to the target images. In such cases, label assigner 30 is connected to an input receiver that receives input from a user, and is configured to be able to obtain the input received by the input receiver. Label assigner 30 may include, for example, a communication interface that communicates with the input receiver. The input receiver is, for example, a button, keyboard, touch panel, microphone, or the like, but is not limited thereto. Label assigner 30 may be configured to be able to automatically assign labels using an image segmentation model or the like that performs pixel-level classification.

Second training processor 40 executes a process of training the target model using at least the target images assigned with labels by label assigner 30 (i.e., the labeled images). In the present embodiment, second training processor 40 executes a process of training the target model using the target images (i.e., the labeled images) and images not selected by image selector 20 from among the plurality of images (i.e., the unlabeled images). Note that training by second training processor 40 also includes retraining.

Storage 50 is a storage device that stores various types of information for training the target model. For example, storage 50 stores FNPM 13 and the plurality of images. Storage 50 is realized by, for example, semiconductor memory or a hard disk drive (HDD), but is not limited thereto.

Note that in information processing device 100, for example, each of first training processor 10, image selector 20, and second training processor 40 may be realized as a standalone device. For example, first training processor 10 may be realized as a training device that executes a training process for training FNPM 13. Image selector 20 may be realized as an image selection device that selects target images to be labeled from a plurality of images using FNPM 13. Second training processor 40 may be realized as a training device that executes a process for training (for example, retraining) the target model using an ADA technique corresponding to the object detection model.

### [2. Operation of Information Processing Device]

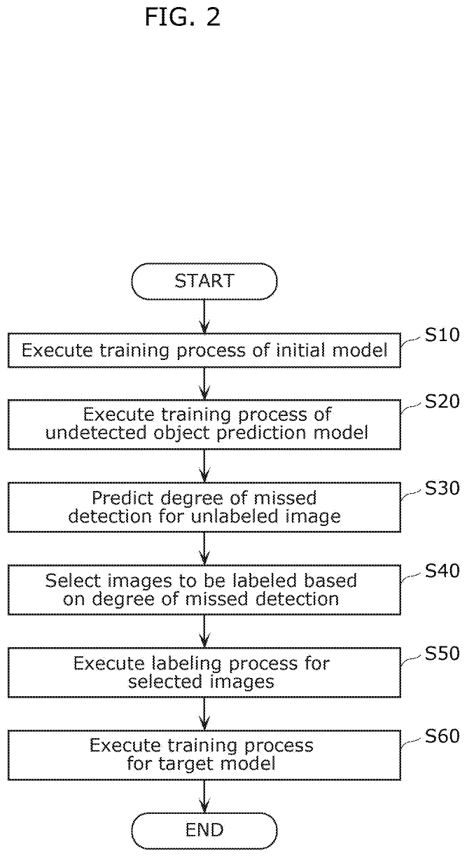

Next, the operation of information processing device 100 configured as described above will be described with reference to FIG. 2 through FIG. 4. FIG. 2 is a flowchart illustrating the operation (image selection method and training method) of information processing device 100 according to the present embodiment. Note that at the time of step S10 illustrated in FIG. 2, feature extractor 11 has been trained, and the training process step for feature extractor 11 is omitted in FIG. 2.

Information processing device 100 mainly executes (i) training an initial model using an unsupervised domain adaptation technique with an existing environment image D_{S} (see FIG. 3) and a new environment image D_{T} (unlabeled image D_{UT} and labeled image D_{LT}) (see FIG. 3), (ii) sampling a budget amount of unlabeled images D_{UT} using an acquisition function (for example, “Acquisition Function” in FIG. 3), assigning labels and adding to labeled images D_{LT}, and (iii) training semi-supervised domain adaptation using labeled existing environment images D_{S}, labeled images D_{LT}, and unlabeled images D_{UT}. (ii) and (iii) are repeatedly executed a plurality of times. Here, (i) corresponds to step S10, (ii) corresponds to steps S20 through S50, and (iii) corresponds to step S60.

As illustrated in FIG. 2, second training processor 40 executes a training process of an initial model using existing environment image D_{S} and new environment image D_{T} (S10). Second training processor 40 executes a training process for teacher model 210 and student model 220 (see FIG. 3).

FIG. 3 is a diagram for explaining the training process of a target model according to the present embodiment. FIG. 3 illustrates an overall configuration for executing a training process of the target model, and has teacher-student structure. Teacher model 210 (“Teacher” in FIG. 3) and student model 220 (“Student” in FIG. 3) have the same model configuration but different internal parameters, and teacher model 210 has higher performance than student model 220. Student model 220 is one example of the target model.

Teacher model 210 includes feature extractor 211 (“Backbone” in FIG. 3), domain identifier 213 (“Domain Discriminator” in FIG. 3), detection estimator 214 (“ROI Head” in FIG. 3, and student model 220 includes feature extractor 221 (“Backbone” in FIG. 3), domain identifier 223 (“Domain Discriminator” in FIG. 3), and detection estimator 224 (“ROI Head” in FIG. 3). Student model 220 also includes gradient reversal layers (GRL) between feature extractor 221 and domain identifier 223.

Note that in the present embodiment, data augmentation is performed to improve the generalization performance of the machine learning model. First training processor 10 includes, for example, first data augmenter 230 (“Weak Aug.” in FIG. 3), executes first-degree data augmentation processing (weak data augmentation processing) on input unlabeled image D_{UT} (“Unlabeled Target Data” in FIG. 3), and outputs unlabeled image D_{UT} on which the data augmentation processing has been executed to feature extractor 211. The first-degree data augmentation processing includes, for example, performing at least one of flipping, horizontal translation, or vertical translation on an object appearing in an image. Second training processor 40 includes, for example, second data augmenter 240 (“Strong Aug.” in FIG. 3), executes second-degree data augmentation processing (strong data augmentation processing) that is higher than the first degree on an input image, and outputs the image on which the data augmentation processing has been executed to feature extractor 221. The second-degree data augmentation processing is, for example, data augmentation processing using reinforcement learning.

The area within the thick-line frame in FIG. 3 schematically illustrates processing for (i) selecting target images to be labeled from among a plurality of unlabeled images D_{UT} and (ii) generating labeled images D_{LT} (“Labeled Target Data” in FIG. 3) by labeling the selected target images.

Feature extractor 211 of teacher model 210 outputs feature map 212 of unlabeled image D_{UT} when unlabeled image D_{UT} is input. Note that feature extractor 221 has the same function as feature extractor 211, and outputs feature map 222 of unlabeled image D_{UT} when unlabeled image D_{UT} is input. Feature extractors 211 and 221 also have the same function as feature extractor 11.

Domain identifier 213 outputs an identification result that identifies, based on feature map 212, either the existing environment or the new environment for each element of feature map 212. The identification result has a size of one channel and includes, for example, a real number value for each pixel. The real number value is, for example, a real number value greater than or equal to 0 and less than or equal to 1. Note that domain identifier 223 has the same function as domain identifier 213.

Detection estimator 214 executes object detection on an image and outputs a detection result. Detection estimator 214 outputs a class and a position of a target object in an image. Note that detection estimator 224 has the same function as detection estimator 214.

As illustrated in FIG. 3, second training processor 40 first initializes initial parameters common to teacher model 210 and student model 220 by unsupervised domain adaptation using existing environment image D_{S} and new environment image D_{T}. Active sampling is performed based on a value obtained by evaluating new environment data with an acquisition function. Here, if the model used as the acquisition function has no knowledge regarding new environment data, the acquisition function cannot evaluate appropriately. Therefore, second training processor 40 first trains a model adapted to the new environment by unsupervised domain adaptation. More specifically, alignment between domains at the feature level is performed by adversarial training using the gradient reversal layer and domain identifier 223.

When the parameter of student model 220 is θₛ and the parameter of domain identifier 223 is φₛ, the objective loss function in model initialization (“Adversarial Loss” illustrated in FIG. 3) is expressed by Expression 1 below.

$$\begin{matrix}[ Math . 1 ] & \\ {min}_{{θ}_{s}} {max}_{{ϕ}_{s}} {ℒ}_{init} = {ℒ}_{sup}^{S} + {λℒ}_{adv} & Expression 1\end{matrix}$$

Here, λ is a hyperparameter that controls the weighting of L_{adv} (adversarial loss). Moreover,

$$\begin{matrix}[ Math . 2 ] & \\ {ℒ}_{sup}^{S} & \end{matrix}$$

is a supervised learning loss in the existing environment and is expressed by Expression 2 below.

$$\begin{matrix}[ Math . 3 ] & \\ {ℒ}_{sup}^{S} = \frac{1}{{N}_{S}} {\sum }_{i = 1}^{{N}_{S}} {ℒ}_{det} ( {x}_{i}^{′ S} , {y}_{i}^{′ S} ) & Expression 2\end{matrix}$$

Here, (x′, y′) is an image augmented by second data augmenter 240. Here, superscript s indicates the existing environment, and subscript i indicates the i-th image. L_{det} is a loss of student model 220 (“Detection Loss” illustrated in FIG. 3) and is expressed by Expression 3 below.

$$\begin{matrix}[ Math . 4 ] & \\ {ℒ}_{det} ( {x}_{i} , {y}_{i} ) = \frac{1}{{N}_{bbox}^{i}} {\sum }_{j = 1}^{{N}_{bbox}^{i}} ( {ℒ}_{cls}^{rpn} ( {x}_{i} , {c}_{i , j} ) + {ℒ}_{reg}^{rpn} ( {x}_{i} , {b}_{i , j} ) + {ℒ}_{cls}^{roi} ( {x}_{i} , {c}_{i , j} ) + {ℒ}_{reg}^{roi} ( {x}_{i} , {b}_{i , j} ) ) & Expression 3\end{matrix}$$

$$Here ,$$

$$\begin{matrix}[ Math . 5 ] & \\ {N}_{bbox}^{i} & \end{matrix}$$

is the number of bounding boxes included in ground truth yᵢ.

$$\begin{matrix}[ Math . 6 ] & \\ {ℒ}_{cls}^{rpn} & \end{matrix}$$

This indicates a classification loss in Region Proposal Network (RPN). Note that RPN is positioned between feature extractor 211 and detection estimator 214 illustrated in FIG. 3, and feature map 212 is input thereto.

$$\begin{matrix}[ Math . 7 ] & \\ {ℒ}_{reg}^{rpn} & \end{matrix}$$

This indicates a bounding box regression loss.

$$\begin{matrix}[ Math . 8 ] & \\ {ℒ}_{cls}^{roi} & \end{matrix}$$

This indicates a classification loss in detection estimator 224 (ROI Head).

$$\begin{matrix}[ Math . 9 ] & \\ {ℒ}_{reg}^{roi} & \end{matrix}$$

This is a bounding box regression loss in detection estimator 224. xᵢ indicates the i-th image, b_{i,j} indicates the j-th bounding box coordinates in the i-th image, and c_{i,j} indicates a class index of the j-th bounding box in the i-th image. In such cases, the adversarial loss is expressed by Expression 4 below.

$$\begin{matrix}[ Math . 10 ] & \\ \begin{matrix}{ℒ}_{adv} = - \frac{1}{{N}_{S}} {\sum }_{i = 1}^{{N}_{S}} log ( 1 - D ( {F}_{enc} ( {x}_{i}^{S} ; {θ}_{s} ) ; {ϕ}_{s} ) ) \\ - \frac{1}{{N}_{T}} {\sum }_{i = 1}^{{N}_{T}} log D ( {F}_{enc} ( {x}_{i}^{T} ; {θ}_{s} ) ; {ϕ}_{s} )\end{matrix} & Expression 4\end{matrix}$$

Here, F_{enc} represents feature extractor 221 of student model 220, and D represents domain identifier 223 of student model 220. Second training processor 40 trains domain identifier 223 to identify the existing environment as 1 and identify the new environment as 0. After completing the training process for unsupervised domain adaptation with all data of existing environment images D_{S} and new environment images D_{T}, second training processor 40 copies the parameters of student model 220 to the parameters (θₜ, φₜ) of teacher model 210 (θₜ←θₛ, φₜ←φₛ). With this, information processing device 100 proceeds to the ADA step.

Referring again to FIG. 2, first training processor 10 executes the training process of the undetected object prediction model (S20). First training processor 10 executes a training process for FNPM 13 as the undetected object prediction model. The images used in the training process of step S20 are annotated images, that is, images including labels (annotation information).

FIG. 4 is a diagram for explaining the training process of FNPM 13 according to the present embodiment.

As illustrated in FIG. 4, first training processor 10 includes feature extractor 11, detection estimator 14, missed detection degree calculator 15, and loss calculator 16. Note that in FIG. 4, feature extractor 11 is denoted as “Backbone”, detection estimator 14 is denoted as “ROI (Region of Interest) Head”, missed detection degree calculator 15 is denoted as “False Negative Calculation”, and loss calculator 16 is denoted as “False Negative Prediction Loss”.

Feature extractor 11 constitutes a preceding stage portion of FNPM 13, and is configured such that an image is input and feature map 12 (an intermediate feature amount) of the image is output. For example, feature extractor 11 is configured from a convolutional neural network, and has a function of extracting a feature amount from an input image. For example, feature extractor 11 may be a visual geometry group (VGG) 16 that has been pre-trained using an image database such as Image NET, but is not limited thereto. Feature extractor 11 may also be trained to extract domain-invariant feature amounts. Feature map 12 is output to each of FNPM 13 and detection estimator 14.

Feature extractor 11 may be shared with the feature extractor included in the target model (for example, feature extractor 221 illustrated in FIG. 3). With this, there is an advantage that undetected objects can be estimated with a very small number of parameters.

Next, first training processor 10 inputs feature map 12 output from feature extractor 11 into FNPM 13, and obtains a degree of missed detection of the image corresponding to feature map 12 as an output (estimation result) of FNPM 13. FNPM 13 is a machine learning model that receives a feature amount of an input image as input, and outputs a degree of missed detection based on a number of undetected objects included in the input image, for example, the number of objects that would remain undetected when the input image is input into a predetermined machine learning model or target model. FNPM 13 is one example of the undetected object prediction model, and the output of FNPM 13 here is one example of the first degree of missed detection. Such FNPM 13 can be implemented using any network, but as one example, the configuration illustrated in FIG. 4 will be described.

FNPM 13 is configured to be able to output a predicted value of the degree of missed detection (for example, a predicted value of the number of undetected objects) through a global average pooling layer (“GAP” in FIG. 4) and a fully connected layer (“Sigmoid” in FIG. 4). The global average pooling layer is a layer for downsampling input feature map 12. The fully connected layer is a layer for scaling the output of FNPM 13 to a value greater than or equal to 0 and less than or equal to 1 using a Sigmoid function or the like. A value obtained by scaling the number of undetected objects to a value greater than or equal to 0 and less than or equal to 1 is one example of the degree of missed detection.

FNPM 13 also alternately includes linear layers (“Linear” in FIG. 4) that multiply input values by weights and output values obtained by adding biases, and activation layers (“ReLU” in FIG. 4) that transform output values using activation functions. Note that although the activation function used in the activation layers is exemplified by ReLU, the activation function is not limited thereto, and may be a step function, a Sigmoid function, or the like.

Note that FNPM 13 is not limited to the above configuration, and can be configured by any network that receives image feature amounts indicated by feature map 12 as input and outputs a scalar real value obtained by normalizing the number of undetected objects (one example of the degree of missed detection).

Detection estimator 14 receives feature map 12 output from feature extractor 11 as input, and estimates a class and a position of an object for regions determined to be likely to contain an object using region of interest (RoI) pooling. Detection estimator 14 estimates, for example, a class and a position of an object that can be detected by a predetermined machine learning model or target model when feature map 12 is input into that model.

Missed detection degree calculator 15 calculates the number of undetected objects in the image based on the output of detection estimator 14 and the label (ground truth information) of the image corresponding to feature map 12. Missed detection degree calculator 15 identifies each of undetected objects and falsely detected objects based on the output of detection estimator 14 and the ground truth information of the image, and outputs only the number of undetected objects among the undetected objects and the falsely detected objects. Missed detection degree calculator 15 calculates a degree of missed detection greater than or equal to 0 and less than or equal to 1 by dividing the calculated number of undetected objects by a predetermined value, and outputs the calculated degree of missed detection as ground truth information. The degree of missed detection is a value based on the number of objects that would remain undetected when the image is input into the target model, and can be used as ground truth information for the output of FNPM 13 during training of FNPM 13. The output of missed detection degree calculator 15 is one example of the second degree of missed detection.

Loss calculator 16 calculates an error that is the magnitude of deviation between the predicted value that is the output of FNPM 13 (“Prediction” in FIG. 4) and the ground truth that is the output of missed detection degree calculator 15 (“Ground Truth” in FIG. 4), and adjusts the parameters of FNPM 13 using the error as a loss. For example, the loss function for calculating the loss is expressed by Expression 5 below.

$$\begin{matrix}[ Math . 11 ] & \\ {ℒ}_{fn} = \frac{1}{{N}_{S}} {\sum }_{i = 1}^{{N}_{S}} {( G ( {F}_{enc} ( {x}_{i}^{S} ; {θ}_{t} ) ; ψ ) - ℱ𝒩 ( {F}_{head} ( {x}_{i}^{S} ; {θ}_{t} ) , {y}_{i}^{S} ) )}^{2} + \frac{1}{{N}_{LT}} {\sum }_{i = 1}^{{N}_{LT}} {( G ( {F}_{enc} ( {x}_{i}^{LT} ; {θ}_{t} ) ; ψ ) - ℱ𝒩 ( {F}_{head} ( {x}_{i}^{LT} ; {θ}_{t} ) , {y}_{i}^{LT} ) )}^{2} & Expression 5\end{matrix}$$

Here, G and y represent FNPM 13 and its parameters, and F_{head} represents the head (ROI Head) of the detection model (e.g., the target model). FN ( . . . , . . . ) is a function that calculates the number of undetected objects for the detection result. Detection result F_{head}(x; θ) and ground truth y are compared, ground truth bounding boxes to which a detection result having an intersection over union (IoU) greater than or equal to a threshold in the same class was not assigned are treated as undetected, and the number thereof is calculated.

Because the ground truth of the number of undetected objects is calculated based on the detection model, the ground truth also changes with updates to the detection model, resulting in a bilevel optimization problem, and it is difficult to stably converge FNPM 13. In response to this, inspired by the training method of reinforcement learning, the detection model and FNPM 13 are alternately optimized. More specifically, because FNPM 13 is used only for active sampling, it is not updated during training of the detection model (see FIG. 3). Before performing active sampling, the parameters of the detection model are fixed, and only FNPM 13 is updated. With this, it is possible to optimize both the detection model and FNPM 13 in a simple and stable manner.

Note that the method of adjusting the parameters of FNPM 13 is not particularly limited, and known methods such as backpropagation may be used.

Referring again to FIG. 2, next, image selector 20 predicts the degree of missed detection for the unlabeled image using FNPM 13 generated by first training processor 10 (S30). Image selector 20 obtains a prediction result of the degree of missed detection in unlabeled image Dur by inputting feature map 212 output from feature extractor 211 into FNPM 13.

Acquirer 250 included in image selector 20 obtains an output from FNPM 13 using an acquisition function (“Acquisition Function” in FIG. 3). Acquirer 250 may further obtain outputs from domain identifier 213 and uncertainty estimator 260 (“Uncertainty Estimation” in FIG. 3). Acquirer 250 may include a communication interface.

Next, image selector 20 selects images to be labeled (target images) from among the plurality of unlabeled images D_{UT} based on the degree of missed detection of each of the plurality of unlabeled images D_{UT} obtained by acquirer 250 (S40). Image selector 20 selects, as images to be labeled, images for which the degree of missed detection is greater than or equal to a first predetermined degree, or a second predetermined number of top images in terms of the degree of missed detection. Image selector 20 may select, as images to be labeled, for example, images among unlabeled images Dur captured in the new environment for which the degree of missed detection is greater than or equal to a first predetermined degree, or a second predetermined number of top images in terms of the degree of missed detection.

Note that in the example of FIG. 3, acquirer 250 obtains information indicating uncertainty for unlabeled images D_{UT} from uncertainty estimator 260. Image selector 20 may select images to be labeled based on information indicating uncertainty in addition to the degrees of missed detection corresponding to unlabeled images D_{UT}. Image selector 20 may, for example, calculate one score for each of the plurality of unlabeled images D_{UT} based on a first score based on the degree of missed detection and a second score based on uncertainty, and select images to be labeled based on the score of each of the plurality of unlabeled images D_{UT}. When the first score has a large value when the degree of missed detection is high, and the second score has a large value when the uncertainty is high, image selector 20 may select, as images to be labeled, images among the plurality of unlabeled images D_{UT} for which the score is greater than or equal to the first score, or a third predetermined number of top images.

Note that the method of selecting images to be labeled is not limited to the above, and examples using other metrics are described below.

In object detection, the uncertainty of bounding box localization is also important, but unlike the entropy of class probabilities, it may be difficult to determine uncertainty from normal estimated coordinates. Accordingly, in the present embodiment, variational inference using Monte Carlo dropout (MCDropout) may be used to treat the parameters of student model 220 as a probability distribution, quantify the variation in estimated coordinates due to model fluctuations, and use this as metric of uncertainty.

Detection estimator 214 of teacher model 210 and detection estimator 224 of student model 220 each include an MCDropout layer, and when the predicted coordinates and predicted class probability of student model 220 are respectively expressed as

$$\begin{matrix}[ Math . 12 ] & \\ {\hat{b}}_{i} & \end{matrix}$$

$$\begin{matrix}[ Math . 13 ] & \\ {\hat{p}}_{i} & \end{matrix}$$

the following Expression 6 is used to calculate the predicted coordinates and predicted class probability of teacher model 210.

$$\begin{matrix}[ Math . 14 ] & \\ \{ {\hat{b}}_{i} ( ξ ) , {\hat{p}}_{i} ( ξ ) \} = {F}_{head} ( {x}_{i} ; {θ}_{t} , ξ ) , where ξ ∼ Ber ( η ) & Expression 6\end{matrix}$$

Here, Ber(η) is a Bernoulli distribution with dropout rate η.

A plurality of prediction results can be obtained by performing variational inference multiple times. In the present embodiment, second training processor 40 calculates the mean and variance from the prediction results obtained from multiple iterations, and uses these means

$$\begin{matrix}[ Math . 15 ] & \\ ( {\hat{b}}_{i}^{mean} , {\hat{p}}_{i}^{{mean}_{}} ) & \end{matrix}$$

as prediction results that take into account model fluctuations, and the variance

$$\begin{matrix}[ Math . 16 ] & \\ {\hat{b}}_{i}^{v ar} & \end{matrix}$$

of the estimated coordinates as the uncertainty of localization to quantify the uncertainty.

$$\begin{matrix}[ Math . 17 ] & \\ {\hat{b}}_{i}^{mean} = \frac{1}{M} {\sum }_{m = 1}^{M} {\hat{b}}_{i , m} , {\hat{p}}_{i}^{{mean}_{}} = \frac{1}{M} {\sum }_{m = 1}^{M} {\hat{b}}_{i , m} & Expression 7\end{matrix}$$

$$\begin{matrix}[ Math . 18 ] & \\ {\hat{b}}_{i}^{v ar} = \frac{1}{M - 1} {\sum }_{m = 1}^{M} {( {\hat{b}}_{i , m} , {\hat{b}}_{i}^{{mean}_{}} )}^{2} & Expression 8\end{matrix}$$

M indicates the number of times variational inference is performed.

Here, image selector 20 may calculate a score (active sampling strategy) by combining three metrics in addition to the degree of missed detection. The diversity, entropy, and localization uncertainty shown below are examples of metrics based on confidence level.

The degree of missed detection (false negatives) is a score that estimates the degree of false negatives of the machine learning model with respect to the input image, and is calculated by Expression 9 below.

$$\begin{matrix}[ Math . 19 ] & \\ {s}_{i}^{fn} = G ( {F}_{enc} ( {x}_{i}^{UT} ; {θ}_{t} ) ; ψ ) & Expression 9\end{matrix}$$

Diversity is a score based on the idea that it is more important for the distribution of the new environment to have high density. Image selector 20 calculates the diversity of each image using Expression 10 below.

$$\begin{matrix}[ Math . 20 ] & \\ {s}_{i}^{div} = \frac{1 - D ( {F}_{enc} ( {x}_{i}^{UT} ; {θ}_{t} ) ; {ϕ}_{t} )}{D ( {F}_{enc} ( {x}_{i}^{UT} ; {θ}_{t} ) ; {ϕ}_{t} )} & Expression 10\end{matrix}$$

Entropy is a score that estimates the uncertainty in class probability. The higher the entropy, the more difficult the image is for the model to predict, and therefore it is assumed to be useful for training. Image selector 20 calculates the entropy of each image using Expression 11 below. Expression 11 calculates the uncertainty in class prediction.

$$\begin{matrix}[ Math . 21 ] & \\ {s}_{i}^{ent} = - \frac{1}{{N}_{bbox}^{i}} {{\sum }_{i = 1}}^{{N}_{bbox}^{i}} {{\sum }_{k = 1}}^{{N}_{c}} {\hat{p}}_{i , j , k}^{mean} log {\hat{p}}_{i , j , k}^{mean} & Expression 11\end{matrix}$$

Localization uncertainty is a score that estimates the uncertainty in the position of bounding boxes in object detection. The variation in the coordinates of the bounding boxes estimated by variational inference is quantified and defined as localization uncertainty. Image selector 20 calculates the localization uncertainty of each image using Expression 12 below.

$$\begin{matrix}[ Math . 22 ] & \\ {s}_{i}^{loc} = \frac{1}{4 {N}_{bbox}^{i}} {{\sum }_{j = 1}}^{{N}_{bbox}^{i}} {{\sum }_{k ∈ \{ x , y , w , h \}}}^{{N}_{c}} {\hat{b}}_{i , j , k}^{va r} & Expression 12\end{matrix}$$

These four metrics (false negatives, diversity, entropy, and localization uncertainty) are used to calculate a score for each image as a final metric, but since each metric has a different range of possible values, metrics with larger values may become dominant. Accordingly, image selector 20 normalizes each metric based on Expression 13 below.

$$\begin{matrix}[ Math . 23 ] & \\ {\hat{s}}_{i}^{m} = max ( 0 , \frac{{s}_{i}^{m} - ( μ ( {s}^{m} ) - 3 σ ( {s}^{m} ) )}{6 σ ( {s}^{m} )} ) & Expression 13\end{matrix}$$

Here, mϵ{fn, div, ent, loc}, and μ and σ represent the mean and standard deviation, respectively. Through preliminary evaluation, it is known that each metric has a unimodal normal distribution, but since outliers may exist, it is difficult to accurately normalize using maximum and minimum values. Therefore, image selector 20 calculates the mean and standard deviation, and scales by 60 based on the normal distribution, thereby reducing the influence of outliers. Image selector 20 calculates the final score of the image by calculating the product of the respective scores, as illustrated in Expression 14 below.

$$\begin{matrix}[ Math . 24 ] & \\ {s}_{i}^{all} = {\hat{s}}_{i}^{fn} {\hat{s}}_{i}^{div} {\hat{s}}_{i}^{ent} {\hat{s}}_{i}^{loc} & Expression 14\end{matrix}$$

Image selector 20 may select images to be labeled based on the final score of each image. Note that image selector 20 may calculate the score of an image based on the degree of missed detection and at least one metric from among diversity, entropy, and localization uncertainty.

Next, label assigner 30 executes a labeling process for the selected images (S50). Label assigner 30, for example, presents the selected images to user U, obtains input of annotation information from user U received by the input receiver, and assigns the obtained annotation information (assigns labels) to unlabeled images D_{UT}, thereby generating labeled images D_{LT}. Note that label assigner 30 does not assign annotations to unlabeled images D_{UT} that were not selected by image selector 20. In this way, active sampling is executed by image selector 20 and label assigner 30.

Next, second training processor 40 executes a training process for the target learning model (which is the target model, i.e., student model 220 illustrated in FIG. 3) using labeled images D_{LT} assigned with labels by label assigner 30 (S60). In the present embodiment, second training processor 40 further executes a training process for the target model using unlabeled images D_{UT} that were not selected by image selector 20 and existing environment images D_{S}. Existing environment images D_{S} include, for example, images captured in an existing environment that were used in a past training process for the target model.

Here, in semi-supervised domain adaptation, training is performed by adding images in the new environment assigned with labels for the budget amount (for example, a preset number) through active sampling. Second training processor 40 executes a training process in a semi-supervised learning framework that utilizes not only labeled images D_{LT} but also unlabeled images D_{UT}. Second training processor 40 also performs supervised learning using existing environment images D_{S} and labeled images D_{LT} in the new environment.

Second training processor 40 also performs unsupervised learning by assigning pseudo-labels 270 (see FIG. 3) that take into account the model's uncertainty for unlabeled images Dur in the new environment. Pseudo-label 270 is a label based on a classification result of teacher model 210. Second training processor 40 trains student model 220 using unlabeled images D_{UT} assigned with pseudo-labels 270 using teacher model 210. More specifically, second training processor 40 excludes images with pseudo-labels 270 having high uncertainty by utilizing the model's uncertainty. Second training processor 40 excludes, from images to be used for training student model 220, images having uncertainty greater than or equal to a predetermined value from among unlabeled images D_{UT} assigned with pseudo-labels 270. With this, in training student model 220, student model 220 becomes less susceptible to the influence of errors in pseudo-labels 270. Second training processor 40 calculates various values using Expressions 15 to 20 below.

The objective loss function is expressed by Expression 15 below.

$$\begin{matrix}[ Math . 25 ] & \\ {min}_{{θ}_{s}} {max}_{{ϕ}_{s}} {ℒ}_{total} = {ℒ}_{sup}^{S} + {ℒ}_{sup}^{LT} + {ℒ}_{unsup} + {λℒ}_{adv} & Expression 15\end{matrix}$$

$$\begin{matrix}[ Math . 26 ] & \\ {ℒ}_{sup}^{LT} & \end{matrix}$$

is a supervised learning loss in labeled images D_{LT} in the new environment and is calculated in the same manner as Expression 3.

$$\begin{matrix}[ Math . 27 ] & \\ {ℒ}_{unsup} & \end{matrix}$$

is an unsupervised detection loss in unlabeled images D_{UT} in the new environment (“Unsupervised Loss” illustrated in FIG. 3) and is expressed by Expression 16 below.

$$\begin{matrix}[ Math . 28 ] & \\ {ℒ}_{unsup} = \frac{1}{{N}_{UT}} {{\sum }_{i = 1}}^{{N}_{UT}} \frac{1}{{N}_{bbox}^{i}} {{\sum }_{j = 1}}^{{N}_{bbox}^{i}} {𝕀}_{bbox} ( {\hat{b}}_{i , j}^{va r} ) {𝕀}_{conf} ( {\hat{p}}_{i , j}^{mean} ) \\ [ {ℒ}_{cls}^{rpn} ( {x}_{i}^{′ UT} , {c}_{i , j}^{PL} ) + {ℒ}_{cls}^{roi} ( {x}_{i}^{′ UT} , {c}_{i , j}^{PL} ) ] & Expression 16\end{matrix}$$

Here,

$$\begin{matrix}[ Math . 29 ] & \\ {𝕀}_{bbox} ( {\hat{b}}_{i , j}^{va r} ) & \end{matrix}$$

is an exponential function and is expressed by Expression 17 below.

$$\begin{matrix}[ Math . 30 ] & \\ {𝕀}_{bbox} ( {\hat{b}}_{i , j}^{va r} ) = \{ \begin{matrix}1 , & if \frac{1}{4} {\sum }_{k ∈ \{ x , y , w , h \}} {\hat{b}}_{i , j , k}^{va r} \leq γ \\ 0 , & otherwise ,\end{matrix} & Expression 17\end{matrix}$$

Here, γ is a threshold for utilizing pseudo-labels 270 having a variance less than or equal to a certain value. Moreover,

$$\begin{matrix}[ Math . 31 ] & \\ {𝕀}_{conf} ( {\hat{p}}_{i , j}^{mean} ) & \end{matrix}$$

is an exponential function and is expressed by Expression 18 below.

$$\begin{matrix}[ Math . 32 ] & \\ {𝕀}_{conf} ( {\hat{p}}_{i , j}^{mean} ) = \{ \begin{matrix}1 , & if max ( {\hat{p}}_{i , j}^{mean} ) \geq τ \\ 0 , & otherwise ,\end{matrix} & Expression 18\end{matrix}$$

Here, T is a threshold for utilizing pseudo-labels 270 when the maximum value of the class probability is greater than or equal to a certain value. Pseudo-label 270 is defined by Expression 19 below.

$$\begin{matrix}[ Math . 33 ] & \\ {c}_{i , j}^{PL} = arg max ( {\hat{p}}_{i , j}^{mean} ) & Expression 19\end{matrix}$$

Second training processor 40 trains student model 220 and updates teacher model 210 by exponential moving average (EMA). The update of teacher model 210 is expressed by Expression 20 below.

$${θ}_{t} ← a {θ}_{t} + ( 1 - a ) {θ}_{s} , {φ}_{t} ← a {φ}_{t} + ( 1 - a ) {φ}_{t} \qquad Expression 20$$

Here, α represents the update ratio.

As described above, second training processor 40 repeatedly executes training of student model 220 and updating of teacher model 210.

### OTHER EMBODIMENTS

Hereinbefore, the image selection device and the like according to one or more aspects have been described based on one or more embodiments, but the present disclosure is not limited to these embodiments. Various modifications to the present embodiment that may be conceived by those skilled in the art, as well as embodiments resulting from combinations of elements from different embodiments, are also intended to be included within the present disclosure as long as these do not depart from the essence of the present disclosure.

For example, the degree of missed detection in the above embodiment may be, for example, the number of undetected objects itself.

Each element may be configured using dedicated hardware, or may be implemented by executing a software program suitable for the element. Each element may be implemented by a program execution unit such as a CPU or processor reading and executing a software program recorded on a recording medium such as a hard disk or semiconductor memory.

The order in which the steps are executed in the flow charts are mere examples presented for illustrative purposes; the steps may be executed in a different order. Moreover, some of the steps may be executed at the same time as (in parallel with) other steps, or some of the steps may not be executed.

Moreover, the division of the function blocks in the block diagrams are mere examples. A plurality of function blocks may be realized as a single function block, a single function block may be divided into a plurality of function blocks, or a portion of functions of one block may be transferred to a different function block. A plurality of function blocks which share similar functions can be processed by standalone hardware or software in parallel or time-shared.

The information processing device (for example, the image selection device) according to the above embodiment may be implemented as a single device or may be implemented by a plurality of devices. When the information processing device is implemented by a plurality of devices, the elements included in the information processing device may be distributed among the plurality of devices in any manner. When the information processing device is implemented by a plurality of devices, the communication method between the plurality of devices is not particularly limited, and may be wireless or wired communication. A combination of wireless communication and wired communication may be used between the devices. The same applies to the image selection device and each training device.

Each element described in the above embodiments and the like may be implemented as software, and typically, may be implemented as an LSI circuit, which is an integrated circuit. These elements may be integrated into individual chips, or a portion or all of the elements may be integrated into one chip. Although the term LSI is used here, depending on the degree of integration, it may also be referred to as an IC, system LSI, super LSI, or ultra LSI. Circuit integration methods are not limited to LSI; the elements may be implemented using dedicated circuits (general-purpose circuits that execute dedicated programs) or a general-purpose processor. A field programmable gate array (FPGA) which allows programming after manufacturing of the LSI circuits or a reconfigurable processor which allows reconfiguration of the connections or settings of circuit cells inside the LSI circuits may be used. Furthermore, if a new technology for circuit integration that replaces LSI emerges due to advances in semiconductor technology or other derived technologies, it goes without saying that the elements may be integrated using that technology.

A system LSI circuit is an ultra-multifunctional LSI circuit manufactured by integrating a plurality of processing units on a single chip, and specifically, is a computer system including a microprocessor, ROM, RAM and the like. The ROM stores a computer program. The microprocessor operates according to the computer program, thereby enabling the system LSI circuit to achieve its functionality.

One aspect of the present disclosure may be a computer program that causes a computer to execute each of the characteristic steps included in the image selection method and the training method illustrated in FIG. 2.

For example, the program may be a program for causing a computer to execute instructions. One aspect of the present disclosure may be a computer-readable non-transitory recording medium on which such a program is recorded. For example, such a program may be recorded on the recording medium and distributed or circulated. For example, by installing the distributed program on a device having another processor and causing that processor to execute the program, it becomes possible to cause that device to perform each of the above-described processes.

### INDUSTRIAL APPLICABILITY

The present disclosure is applicable to information processing devices or the like that train object detection models.

1. An image selection method executed by a processor using memory, the image selection method comprising:
estimating a degree of missed detection based on a number of undetected objects in each of a plurality of unlabeled images, by inputting the plurality of unlabeled images into an undetected object prediction model; and
selecting one or more unlabeled images to be labeled from among the plurality of unlabeled images, based on the degree of missed detection of each of the plurality of unlabeled images.

2. The image selection method according to claim 1, further comprising:
predicting a first degree of missed detection for an input image by inputting the input image into the undetected object prediction model;
calculating a second degree of missed detection for the input image, based on ground truth information of an object region in the input image; and
training the undetected object prediction model based on the first degree of missed detection and the second degree of missed detection.

3. The image selection method according to claim 1, wherein
the one or more unlabeled images are images selected from among the plurality of unlabeled images based on a magnitude of the degree of missed detection.

4. The image selection method according to claim 3, wherein
the one or more unlabeled images are images, among the plurality of unlabeled images, for which the degree of missed detection is greater than or equal to a first predetermined degree, or are a second predetermined number of top images.

5. The image selection method according to claim 1, wherein
the one or more unlabeled images are images selected further based on a metric based on a confidence level of a detected object in each of the plurality of unlabeled images.

6. The image selection method according to claim 5, wherein
the metric includes an uncertainty indicating a degree of variation in predictions in the undetected object prediction model.

7. The image selection method according to claim 1, wherein
the number of undetected objects is, when an image is input into a target model to be trained, a number of objects, among a plurality of objects included in the image, that are undetectable by the target model.

8. The image selection method according to claim 7, wherein
the target model has been trained using images captured in a first environment, and
the plurality of unlabeled images include images captured in a second environment different from the first environment.

9. A training method comprising:
labeling each of the one or more unlabeled images selected using the image selection method according to claim 1; and
training a target model to be trained using one or more labeled images that are the one or more unlabeled images assigned with labels.

10. An image selection device comprising:
an estimator that estimates a degree of missed detection based on a number of undetected objects in each of a plurality of unlabeled images, by inputting the plurality of unlabeled images into an undetected object prediction model; and
a selector that selects one or more unlabeled images to be labeled from among the plurality of unlabeled images, based on the degree of missed detection of each of the plurality of unlabeled images.

11. A non-transitory computer-readable recording medium having recorded thereon a computer program for causing a computer to execute the image selection method according to claim 1.
